(19) United States
(12) Patent Application Publication
(10) Pub. No.: US 2006/0232123 A1
(43) Pub. Date: Oct. 19, 2006

(54) Wheel and bearing assembly

(76) Inventor: Amara Ross, Long Beach, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/105,684

(22) Filed: Apr. 13, 2005

(51) Int. Cl. B60B 1/00; F16C 19/00

(52) U.S. Cl. 301/5.7

(57) ABSTRACT

There is disclosed herein an improved and simplified wheel and bearing assembly, such as for skates and the like comprising a bearing inner race preferably formed of a plastic material such as polysulfone. A pair of bearing outer races, preferably of a relatively strong material such as titanium or polysulfone, are coupled with outer surfaces of the bearing inner race. Mating surfaces of the bearing inner race and the bearing outer races are configured and are coated with a lubricant to provide bearing surfaces for the wheel. The wheel includes a tire with a glow-in-the-dark material or a reflective material.

The present invention relates to wheels, and more particularly to a relatively simple wheel and bearing assembly useful for skates, skateboards, scooters, luggage, shopping carts, toys and the like.

### BACKGROUND OF THE INVENTION

Various forms of wheels, including skate wheels, have been developed over the years. A typical skate wheel, for example, comprises a rigid annular hub onto which an outer tire is mounted or directly molded thereon. The hub usually is supported by one or a pair of radial bearings which are attached by a shaft to the skate. Wheels for other sports and like items usually have a similar construction. The bearing typically is a ball bearing.

### SUMMARY OF THE INVENTION

In accordance with a preferred embodiment of the present invention, a new form of wheel and bearing assembly particularly useful for skates, skateboards, and other wheeled devices, as well as toy products, does not incorporate the usual ball bearing assembly but rather comprises a hub in the form of a bearing inner race which supports a tire, and a pair of bearing outer races coupled with the inner race. Certain outer surfaces of the bearing inner race and certain inner surfaces of the bearing outer races are configured in a manner to form a mating bearing having a dry film lubricant on the mating surfaces. The tire is molded or otherwise disposed on the inner race and which preferably is formed of polyurethane. The bearing outer races preferably are machined from titanium, aluminum, or a suitable polyurethane, but preferably from polysulfone. The outer races also preferably are formed of polysulfone and mate and snap together. The mating surfaces of the inner race and outer races are provided with a suitable solid film lubricant.

Accordingly, it is a principal object of the present invention to provide a new form of wheel and bearing assembly.

Another object of the present invention is to provide a simple form of wheel suitable for use for skates, skateboards, toys, and other wheeled uses.

### BRIEF DESCRIPTION OF THE DRAWINGS

FIG. 1a illustrates a completed wheel and bearing assembly and FIG. 1b and FIG. 1c illustrate, respectively, a “glow-in-the-dark” version and a reflective version according to the present invention;

FIG. 2 is an exploded view showing the components of a wheel and bearing assembly of the present invention;

FIGS. 3a and 3b are side elevational views of two embodiments thereof,

FIGS. 4a and 4b are detailed cross-sectional views of the assembly, further showing an axle on which it can be mounted, wherein FIG. 4a illustrates outer races of metal and FIG. 4b illustrates outer races of plastic;

FIGS. 5a and 5b are enlarged detailed cross-sectional views of a portion of an inner race and an outer race further illustrating the mating surfaces thereof, wherein FIG. 5a illustrates an outer race of metal and FIG. 5b illustrates an outer race of plastic.

FIGS. 6a and 6b are perspective views of the wheel assembly with a snap lock for metal and plastic versions;

FIGS. 7a and 7b are enlarged views of the bearing outer races illustrating extended portions coupling together the metal races (7a) allowing the plastic races to be snapped together (7b).

### DETAILED DESCRIPTION

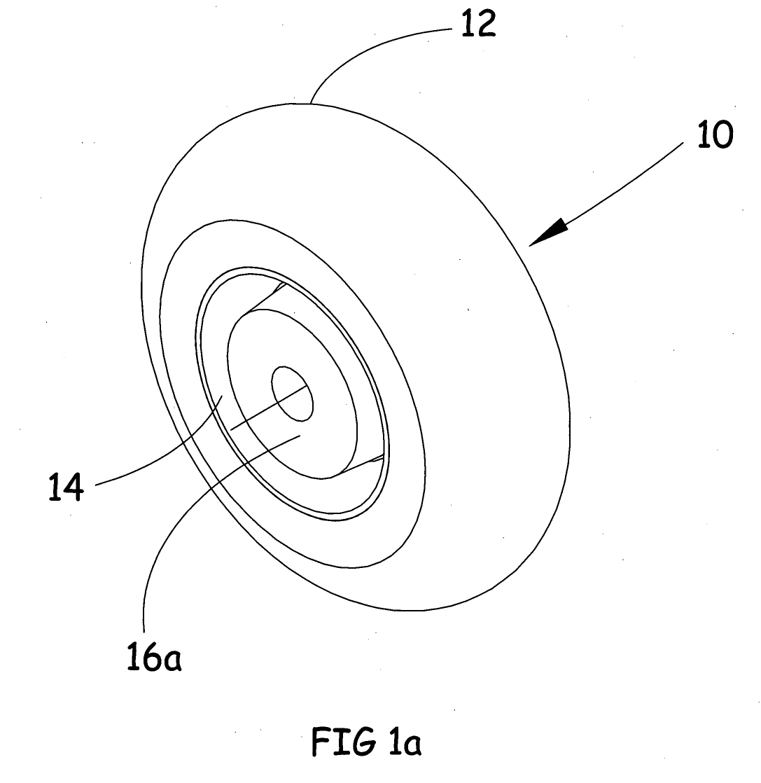

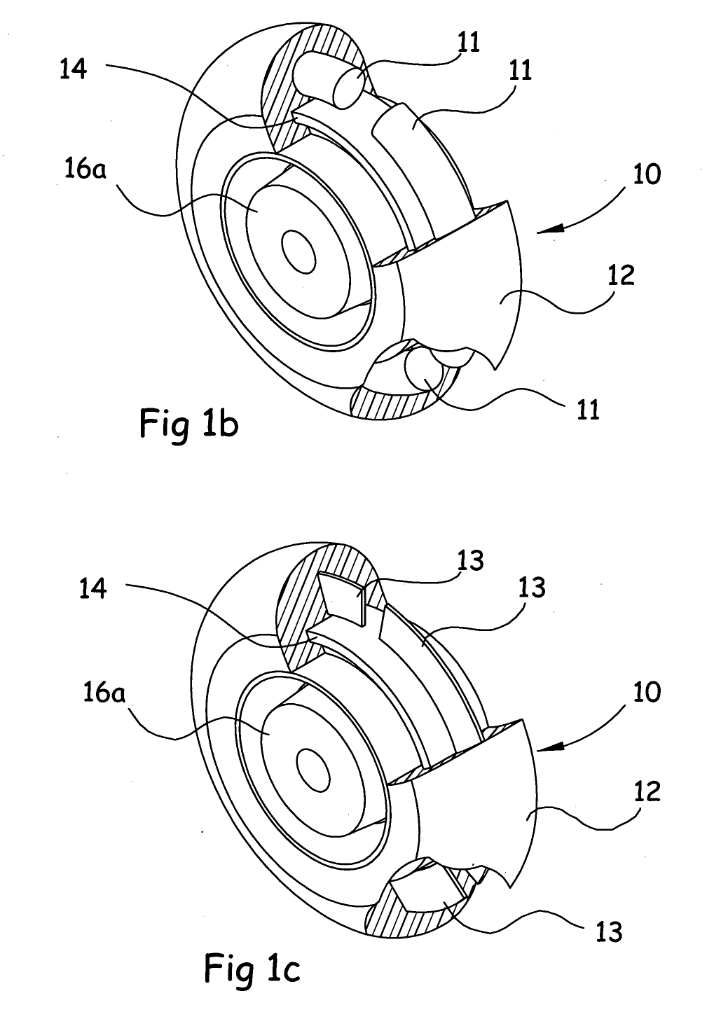

Turning now to the drawings, FIG. 1a illustrates a wheel 10 having an outer tire 12, bearing inner race 14 forming a hub onto which the tire 12 is mounted or molded, and one bearing outer race 16a of a pair of bearing outer races 16a, 16b. FIG. 1b shows a version with a glow-in-the-dark material 11, and FIG. 1c shows a version with reflective material 13.

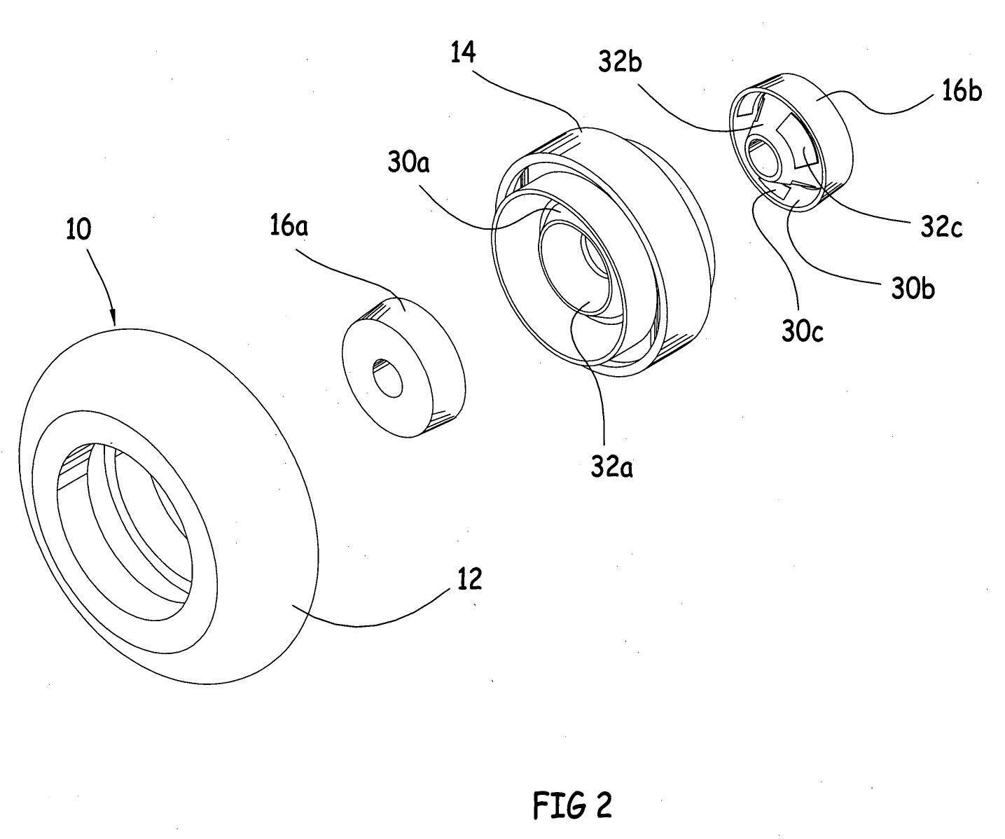

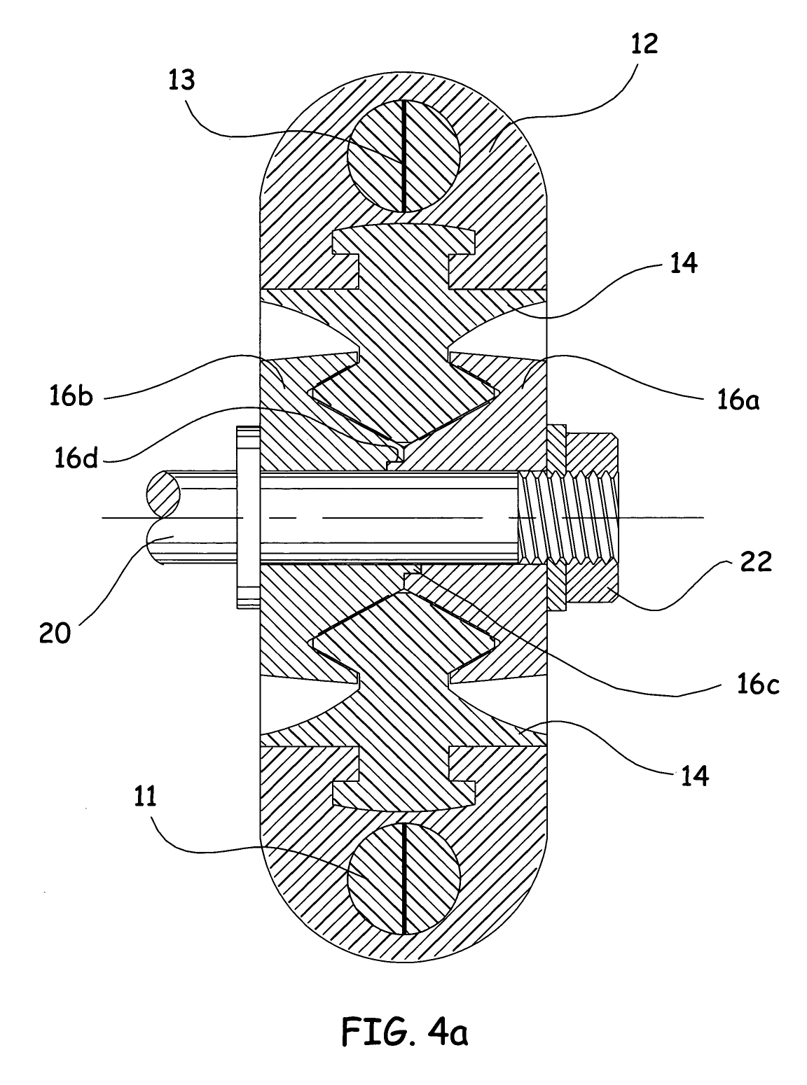

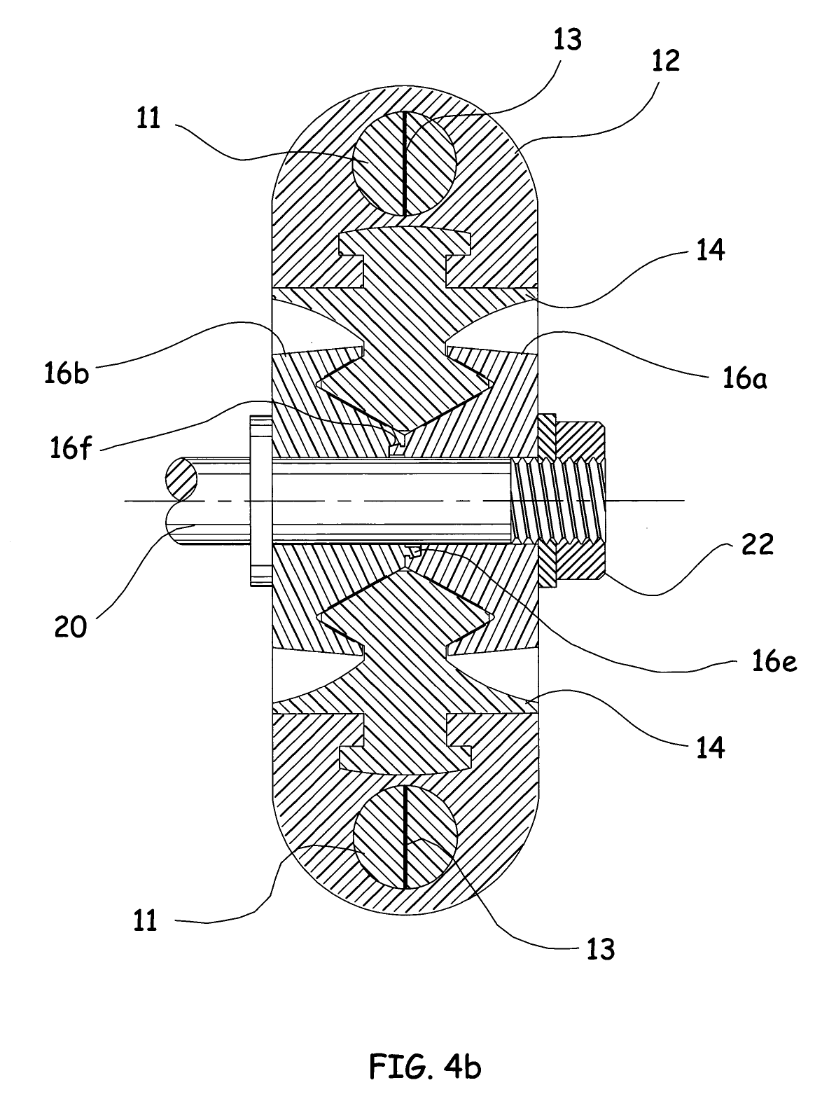

FIG. 2 is an exploded view of the wheel 10 better illustrating in particular the bearing inner race 14 and the bearing outer race 16a and bearing outer race 16b which mate with the inner race 14 on both sides thereof as will be apparent from a review of FIG. 2 and FIGS. 4a and 4b. FIG. 2 also illustrates cavities or pockets 30c and 32c which will be explained later.

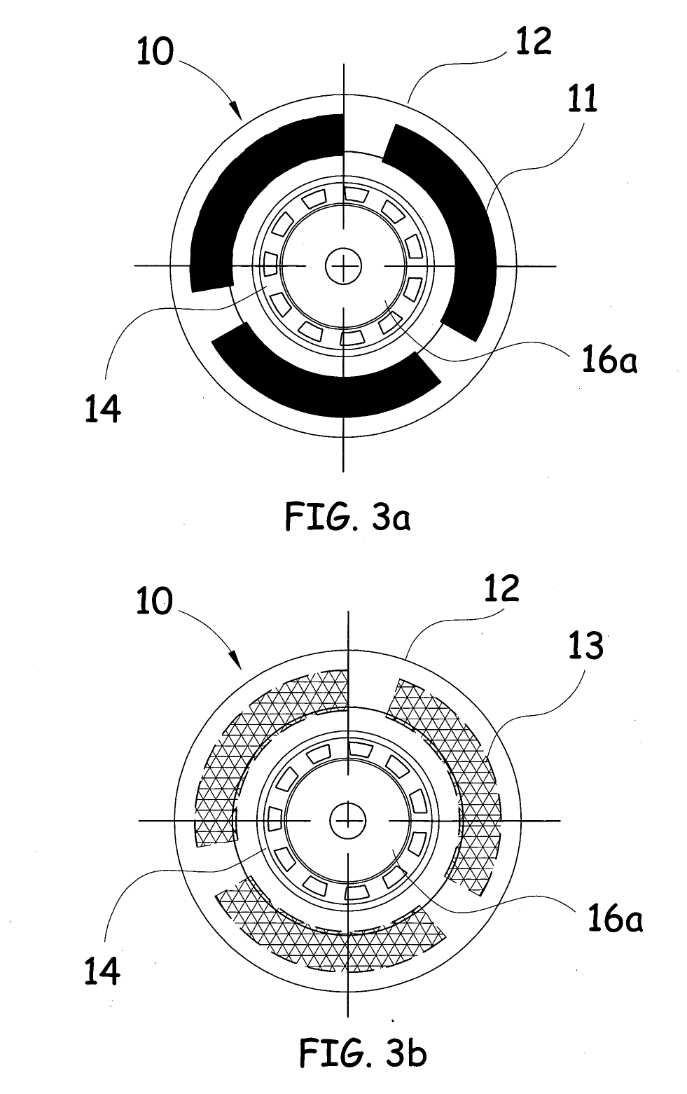

FIGS. 3a and 3b are elevational views further showing the wheel 10 and its components, and particularly the glow-in-the-dark material 11 and reflective material 13.

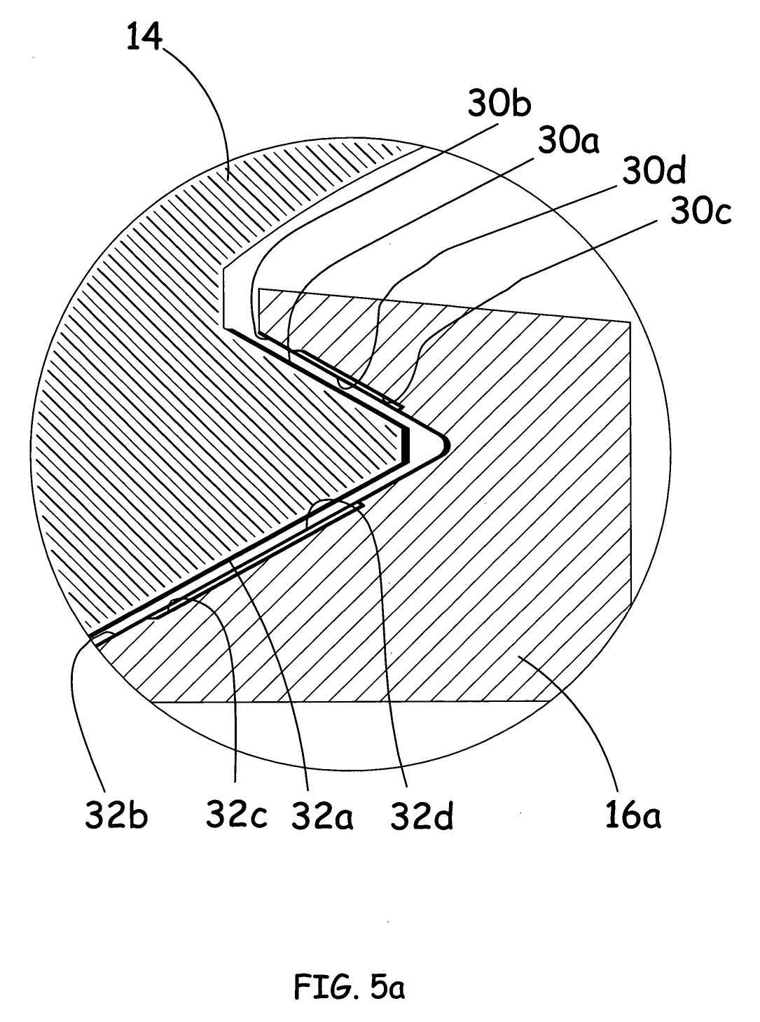

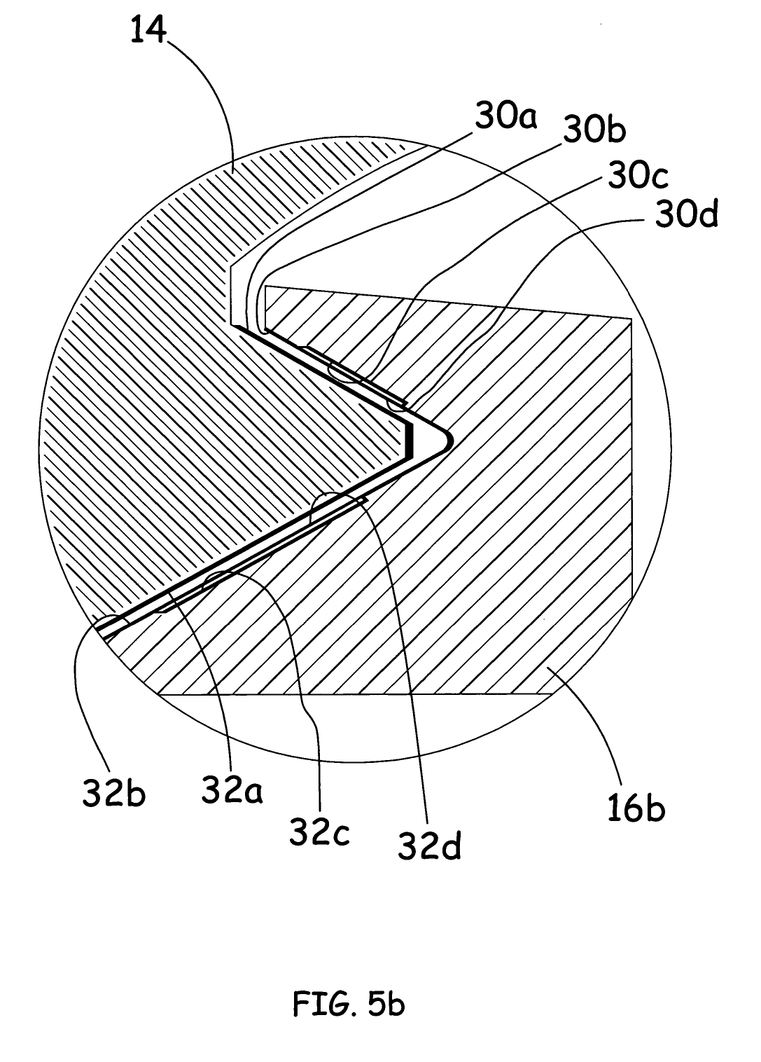

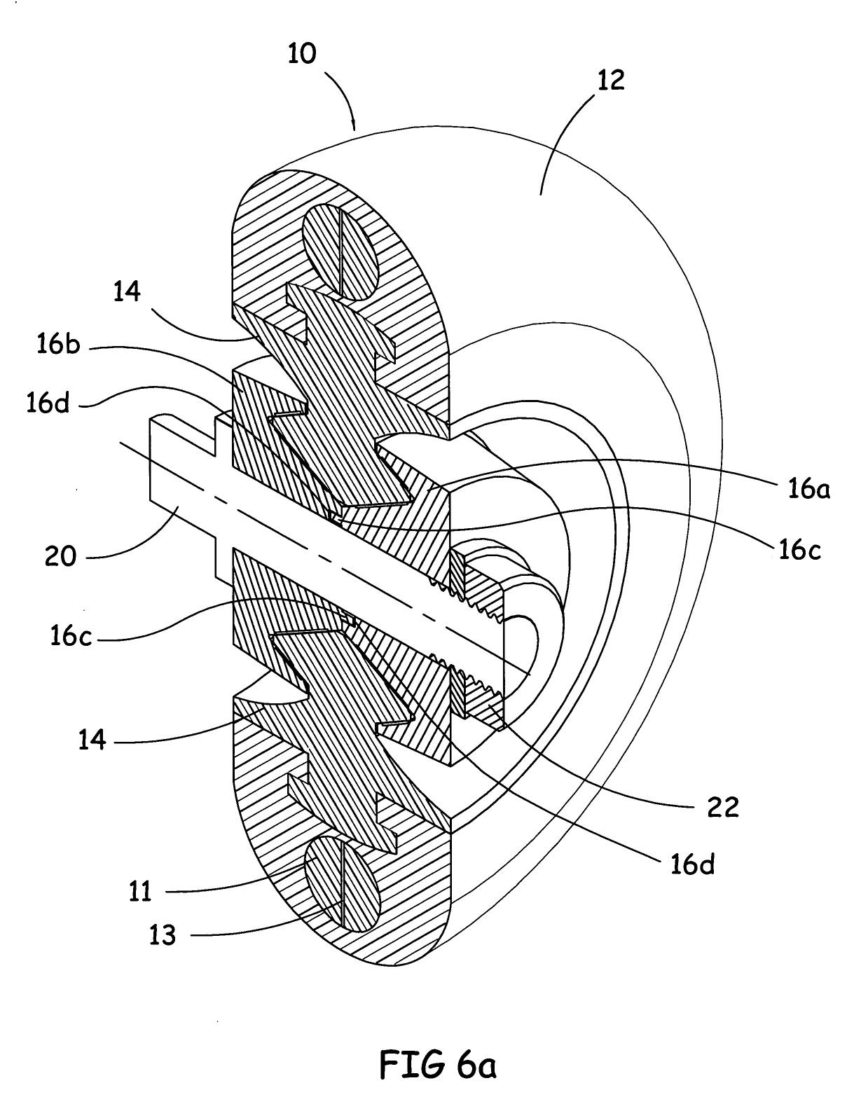

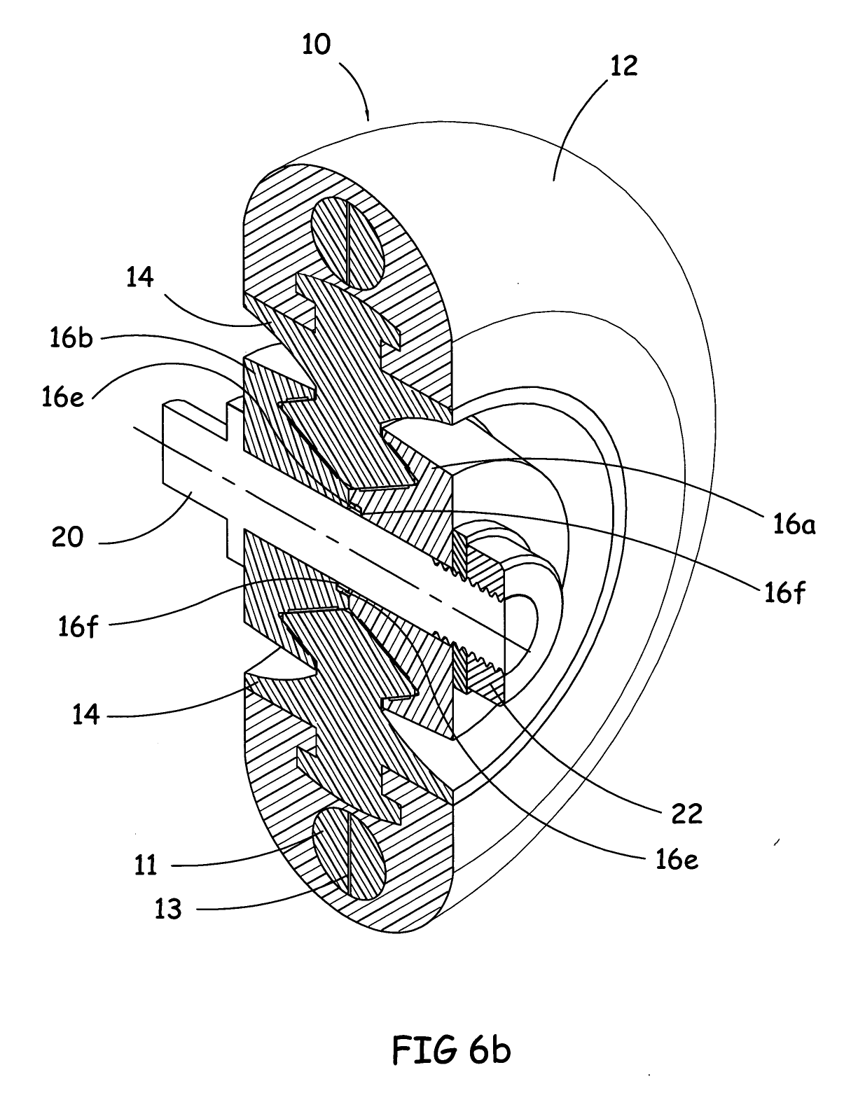

Turning now to FIGS. 4 and 5, FIG. 4 is a detailed cross-sectional view of the entire wheel 10 further illustrating the tire 12, bearing inner race 14 onto which the tire is disposed, and the pair of bearing outer races 16a and 16b. FIG. 4 further illustrates an axle 20, and nut 22 or other fastener, which extends through the outer races 16a, 16b and secures them to the item to which the wheel 10 is attached, such as an inline skate, a skateboard, or other wheeled device (not shown). FIGS. 4a and 5a illustrate the outer race 16 formed of metal, and FIGS. 4b and 5b illustrate the outer race 16 formed of plastic. Both of the glow in the dark material 11 and the reflective material 13 are shown in FIGS. 4 and 6 for illustration, it being understood that one or the other would be present, usually not both.

Exemplary materials comprise a suitable plastic for the tire 12, such as polyurethane. The bearing inner race 14 preferably is formed of polysulfone and can include holes into which the tire material can flow during molding. The bearing outer races 16a, 16b can be formed of various materials depending on the uses to which the wheel 10 will be placed. For example, for high impact uses, preferably the bearing outer races 16a, 16b are metal, such as machined of titanium. For medium duty, 7075 aluminum is suitable, and for light duty, polyurethane 80D Shore hardness is suitable. Polysulfone is particularly good for the races 16.

Still referring to FIG. 4, and particularly to the detail in FIG. 5, an important aspect of the present invention is the generally “V” configuration of surfaces 30a, 30b, and 32a, 32b. Surfaces 30a, 30b in an exemplary embodiment can be 30 degrees with respect to the axis of the wheel, and surfaces 32a, 32b can be 29 degrees with respect to the axis of the wheel. Importantly, each of these surfaces 30a, 30b, 32a and 32b is coated with a solid film lubricant such as Everlube 620C sold by Everlube Products. The surfaces 30a, 30b, 32a and 32b are shown in heavy lines in FIGS. 5a and 5b to represent this coating. The surfaces 30a, 32a, of the race 14 are impregnated with lubricant during molding of the race 14. The lubricant is baked on the surfaces 30b and 32b of the races 16a and 16b.

Importantly, the races 16a and 16b further include pockets 30c and 32c as seen particularly in FIG. 5 for containing respective lubricant 30d and 32d. These pockets 30c and 32c not only reduce the surface area and contact between races 16 and 14, but also provide improved lubrication. Thus, not only is there surface lubrication as indicated by the heavy lines 30a, 30b, 32a and 32b, but also lubricant 30d and 32d is provided in the respective pockets 30c and 32c. The total surface removal for forming the pockets 30d and 32d is approximately 25-30 percent, and preferably 27 percent. The pockets 30d and 32d are too small in FIGS. 4a and 4b to label.

The inner race 14 can be molded, and the tire 12 can be molded onto the outer circumference of the inner race 14, or mounted thereon in any other suitable manner. When the tire 12 is worn, the tire 12 and race 14 (which acts as a hub) assembly is discarded.

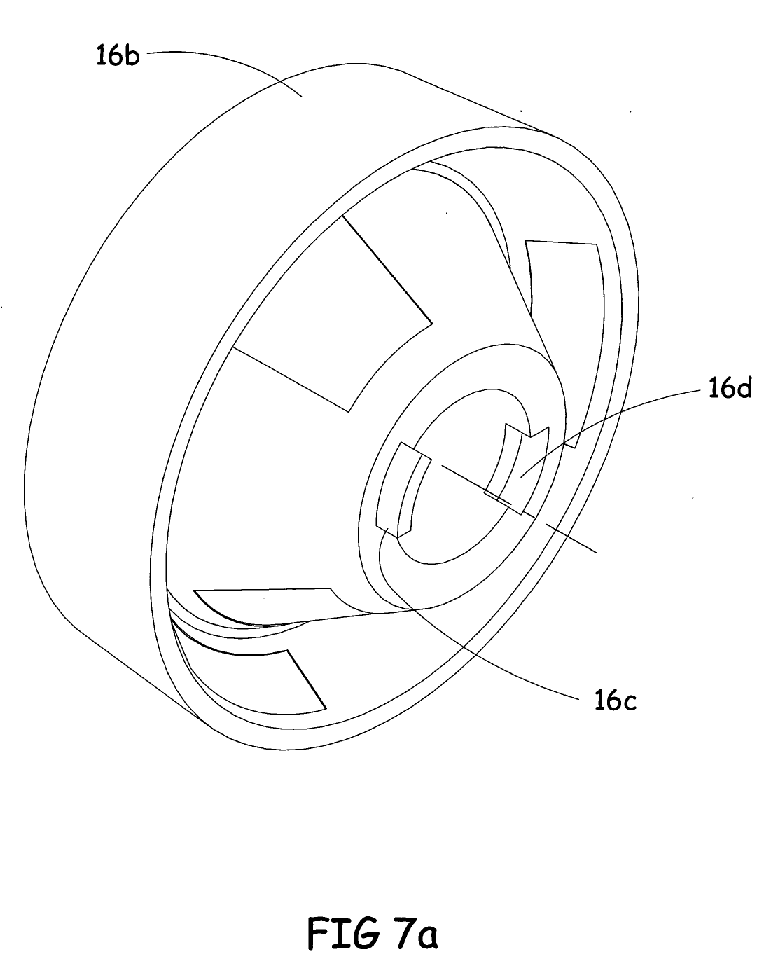

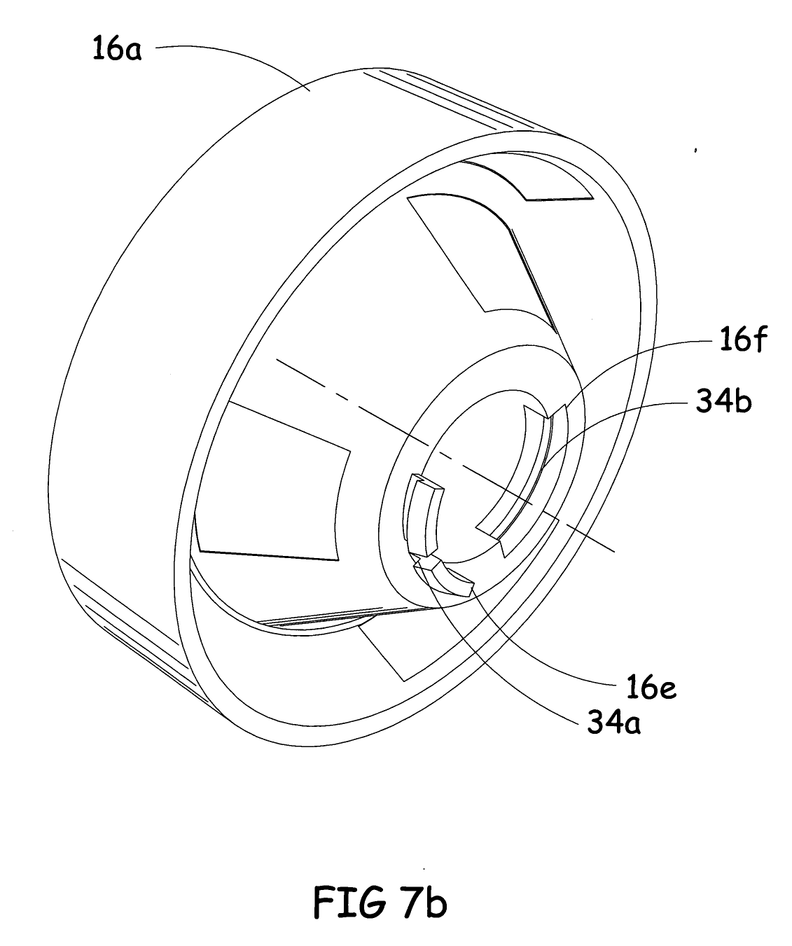

Other important aspects of the present invention are the manner in which either the metal or the plastic bearing outer races 16a and 16b are configured so that their inner ends 16c-16f fit together. In the case of the metal races in FIG. 4a the outer race 16a has an annular skirt 16c which fits within an annular opening in race 16b defined by an annular skirt 16d. Of particular significance is the manner in which annular segments 16e of race 16a fit with annular segments 16f of race 16b so that the plastic races 16a and 16b can be snapped together. The structure of the annular segments is better seen in FIGS. 7a and 7b. The skirts or segments 16c and 16d in each of outer races 16a and 16b are alike and in the assembly of the races 16a and 16b together, race 16c mates with 16d, and this keeps race 16a from rotating with respect to race 16b. In a similar manner, the annular skirts or segments 16e and 16f not only mate together but they do so in a snapping fashion because of a raised area 34a and a groove 34b.

Turning again to FIG. 4, it is preferable that the tire 12 be formed of a transparent or translucent material, clear or coated, and further include either a glow-in-the-dark material 11 or a reflector 13. Both could be used, but this would present a difficult construction or molding problem and, thus, the preference is that if glow-in-the-dark material is used, it be in the form of an annular ring 11 (or reflector 13 not be present) within the tire 12, or alternatively only the reflector 13 is provided as an annular ring within the tire 12.

As noted earlier, wheels according to the present invention are particularly useful for skate devices, such as inline skates, skateboards, as well as toys. Furthermore, wheels according to the present invention can be used in other applications, such as scooters, luggage, shopping carts, even including items such as bicycles and the like, and industrial equipment.

While embodiments of the present invention have been shown and described, various modifications may be made without departing from the scope of the present invention, and all such modifications and equivalents are intended to be covered.

What is claimed is:

1. A wheel and bearing assembly comprising a bearing inner race having axially outwardly facing surfaces of a general “V” shape wherein the apexes of the “V” axially face outwardly, and having an outer circumference on which a tire is disposed, a pair of bearing outer races each having an inner surface configured to mate with the respective outwardly facing surfaces of the inner race, the inner surface including pockets to reduce the surface area facing the inner race, and the outer races having axial holes therethrough through which an axle can extend for supporting the wheel, and a film lubricant on the mating surfaces of the inner and outer races and in the pockets.

2. An assembly as in claim 1 wherein the tire is formed of polyurethane, the inner race is formed of polysulfone, and the outer bearing races are formed of metal.

3. An assembly as in claim 2 wherein the outer races are formed of titanium.

4. An assembly as in claim 2 wherein the outer races are formed of aluminum.

5. An assembly as in claim 1 wherein the tire, inner race and outer races are formed of plastic.

6. An assembly as in claim 5 wherein the plastic is polysulfone.

7. An assembly as in claim 5 wherein the outer races have annular segments which snap together.

8. An assembly as in claim 1 wherein the lubricant is a solid film lubricant.

9. An assembly as in claim 8 wherein the lubricant is impregnated in the inner race.

10. An assembly as in claim 8 wherein the lubricant is baked on the outer races.

11. An assembly as in claim 1 wherein the tire is molded onto the outer circumference of the inner race, and is disposable.

12. An assembly as in claim 1 wherein the outwardly facing surfaces of the inner race and the inner surfaces of the outer races are formed in a substantially mating “V” shape having surface angles approximately thirty degrees with respect to the axis of the wheel.

13. An assembly as in claim 1 wherein the tire is formed of one of a transparent and a translucent material.

14. An assembly as in claim 1 wherein the tire includes a glow-in-the-dark material.

15. An assembly as in claim 1 wherein the tire includes therein a reflector.

16. A wheel without ball or roller bearings comprising an inner race forming a hub and having axially outwardly facing surfaces of a general “V” shape wherein the apexes of the “V” axially face outwardly, and having an outer circumference on which a transparent or translucent tire may be disposed, the inner race having a plurality of light reflectors thereon, a pair of bearing outer races each having an axially extending inner surface configured to essentially mate with the respective outwardly facing surfaces of the inner race, the outer races each having an axial hole through which an axle can extend for supporting the wheel, and a dry film lubricant on the mating surfaces of the inner and outer races.

17. A wheel as in claim 16 wherein the tire includes a glow-in-the-dark material.

18. A wheel as in claim 16 where the tire includes an internal reflector.
